(19) United States
(12) Patent Application Publication
(10) Pub. No.: US 2021/0148024 A1
(43) Pub. Date: May 20, 2021

(54) Novel ion exchange materials

(71) Applicant: Fortum Power and Heat Oy, Espoo (FI)

(72) Inventors: Risto Harjula, Espoo (FI); Risto Koivula, Helsinki (FI); Mikko Ritala, Espoo (FI); Eero Santala, Klaukkala (FI); Jani Holopainen, Järvenpää (FI); Esko Tusa, Kauniainen (FI)

(21) Appl. No.: 16/616,501

(22) PCT Filed: May 24, 2018
(86) PCT No.: PCT/FI2018/050394

§ 371 Date: Nov. 25, 2019

(30) Foreign Application Priority Data
May 24, 2017 (FI) 20175466

(51) Int. Cl. D04H 1/728; D01D 5/00; B01J 39/02; B01J 20/02; B01J 20/28; B01D 24/36; D04H 1/4382

(52) U.S. Cl. CPC D04H 1/728; D01D 5/0007; B01J 39/02; D04H 1/43838; B01J 20/28007; B01J 20/28038; B01D 24/36; B01J 20/0211

(57) ABSTRACT

The invention relates to a new use of spun, continuous inorganic fibers having a diameter smaller than 1 μm in the form of monolithic structures with at least one dimension equal to or greater than about 50 μm. The monolithic structures are formed by self-entanglement of the continuous fibers as an ion exchange material. In particular the invention relates to a new ion exchange material bed comprising such fibers and ion exchange unit comprising such bed. The invention improves the efficiency and sustainability of ion exchangers.

### FIELD OF THE INVENTION

The invention relates to ion exchange and sorption materials that can be used in various industrial processes, such as purification processes and other separation processes. In particular, the present invention concerns an ion exchange bed and ion exchange unit comprising such material. The present invention also concerns a method of producing particulate matter suitable for use in the present beds.

### BACKGROUND OF THE INVENTION

Conventional industrial separation processes, such as solvent extraction, precipitation, and distillation or evaporation, are generally highly energy-intensive. In a typical case, more than 50% of energy used in process industry is consumed separation processes. Present separation processes also produce large amounts of secondary waste, such as sludges, spent sorbents, and/or involve the use of harmful chemicals.

New sustainable and efficient separation methods are required to achieve the future “zero” discharge limits of pollutants. Ion exchange is a commonly used method for the purification of water from various ionic impurities, to mention only one application area of ion exchange. For the ion exchange process, efficient contact between the solution and the ion exchange material is essential.

Ion exchange applications mostly utilize organic ion exchange resins in bead form. Alternatively, ion exchange resins can be provided in fiber form or as a membrane, as disclosed in US 2009/0166295. Also some inorganic materials have been used for specific applications, e.g. zeolites for water softening and nuclear waste effluent treatment. In recent decades, several new inorganic materials (e.g. titanates, silicotitanates, hexacyanoferrates) have been developed and taken in use for nuclear applications. High selectivity of these materials makes them interesting also for other trace impurity separations than radionuclides, e.g. removal of heavy metals.

The use of organic or inorganic particles for providing ion exchange function in a stock used to manufacture fibrous materials is disclosed in US 2011/0274927. Inorganic particles have also been coupled to ion exchange resin membranes, as disclosed in WO 2014/0168628.

The use of fibrous carbon for sorption of radionuclides is disclosed in U.S. Pat. No. 5,707,922.

Further inorganic fibers are disclosed in JP 561187939, JP 558156347, Wang, H et al., J. Hazard. Mater., December 2013, vol. 265, pp. 158-165 and U.S. Pat. No. 3,994,740. Zinc titanate reactive adsorbents containing multiphase, polycrystalline nanofibers are disclosed in US 2016101408. The adsorbents are used in a process for reducing sulphur levels in gas streams.

Removal of Antimonite (Sb(III)) and Antimonate (Sb(V)) from Aqueous Solution Using Carbon Nanofibers That Are Decorated with Zirconium Oxide (ZrO₂) is disclosed by Jinming Luo et al. in Environ. Sci. Technol. 2015, 49, 11115-11124. Carbon fibers are unsuitable for many uses in which deposition of spent sorbents are contemplated.

Synthesis, characterization, and application of titanate nanotubes for Th(IV) adsorption is discussed by Jianlian Liu et al. in J. Radioanal. Nucl. Chem., vol. 298, no. 2, pp. 1427-1434.

There is still need for improving ion exchange and sorption processes and materials used therefor.

### SUMMARY OF THE INVENTION

It is an aim of the invention to provide a novel solution for improving the efficiency and sustainability of ion exchangers and sorption material. A particular aim is to reduce the amount of ion exchange material or sorption needed per unit of raw material subjected to an ion exchange process or sorption.

It is an aim of the invention to provide a more efficient ion exchange or sorption bed and a unit comprising such a bed.

The invention is based on using spun inorganic fibers as an ion exchange material. Such fibers form a macroscopic three-dimensional fiber network structure in the form of monolithic structures having at least one dimension of at least 50 μm which are mechanically steady and provide a large surface area for ion exchange interactions to take place.

The invention provides, in a first aspect, monolithic structures of inorganic spun fibers having a diameter smaller than 1 μm, said structures having at least one dimension of at least 50 μm.

The monolithic structures can be produced by forming continuous inorganic fibers spun from organic precursors into a fiber mat in as-spun condition; and treating the fibers to remove organic residues from them. The thus-obtained fiber mats have a thickness of at least 50 μm. They can be used as such in ion-exchange or sorption applications. Alternatively, the fiber mats can be broken up to yield inorganic particles having a smallest dimension of at least 50 μm.

The invention further provides an ion exchange or sorption bed comprising continuous inorganic spun fibers capable of binding cations, anions or colloidal particles from liquid media brought in contact with the inorganic fibers, said fibers having a diameter smaller than 1 μm,
the fibers being present in the form of monolithic structures with a smallest dimension of about 50 μm, and
the monolithic structures being formed by self-entanglement of said continuous fibers.

Finally, the invention also provides an ion exchange unit, comprising a housing with an inlet for liquid to be subjected to ion exchange and an outlet for liquid having been subjected to ion exchange. The housing further comprises a bed of an ion exchange material, the bed has a first end which is in liquid contact with the inlet and an opposite second end which is in liquid contact with the outlet. The ion exchange material comprises continuous inorganic fibers having a diameter smaller than 1 μm, the fibers are present in the form of monolithic structures of inorganic material, with a smallest dimension of about 50 μm, and the monolithic structures are formed by self-entanglement of the continuous fibers.

More specifically, the invention is characterized by what is stated in the independent claims.

The invention provides considerable advantages. Importantly, fibers have high surface area to volume ratio, almost as high as particulate matter with corresponding diameter. However, fibers are easier to handle and keep fixed than powders, whose particles typically need to be bound to a separate support material. The fibrous material forms self-supporting and liquid-permeable structures within housings of different kinds. This is important for the manufacture of ion exchanger modules wherein the ion exchanger material must be retained in steady formation. It may be estimated that by exploiting spun inorganic fibers, in particular spun nanofibers, the ion exchanger mass required for a given capacity can be decreased 10-fold, or maybe even up to 100-fold compared with prior ion exchange materials.

Inorganic nanofibers suitable for the present invention can be manufactured using a spinning technique, such as electrospinning, solution blow spinning, centrifugal spinning or electroblowing, as will be explained above. In particular solution blow spinning, centrifugal spinning and electroblowing are readily scalable for industrial production.

The present materials are suitable for use as ion exchange materials or sorbents for removing cations, anions or colloidal particles from liquid media, such as liquid waste, for example nuclide containing liquid waste.

From the environmental and end-users viewpoint, the invention provides a highly efficient and sustainable material for separation of for example trace pollutants, such as radionuclides, heavy metals and oxo-anions (arsenate, chromate, antimonate). As the use of ion exchange material is considerably smaller than before, the amount of waste and need for maintenance of exchanger units is reduced.

The present materials are free from carbon residues and particularly well suited for deposition of spent materials, e.g. in the case where the materials have been used for sorption of radionuclides for purification or decontamination of aqueous liquids containing such radionuclides.

The invention allows production of ion exchange beds which have a processing capacity (amount of liquid processed as sorbent masses per hour) of 1000 to 10000, this being considerably more than that of reference materials available.

Due to the macroscopic, irregular shape of the present particles, the particles will form interlocking structures when arranged in the shape of layers or beds. Therefore, ion-exchange beds can be provided which are sufficiently porous to allow for flow-through of liquids, while still retaining the particles due to the interlocking of the structures.

Next, selected embodiments of the invention and advantages thereof are described in more details with reference to the attached drawings.

### BRIEF DESCRIPTION OF DRAWINGS

FIG. 1 shows a schematic representation of an ion exchange unit comprising an ion exchange bed according to one embodiment of the present technology;

FIGS. 2A and 2B schematically illustrate two different electrospinning systems usable to produce ion exchange material according to the present technology;

FIGS. 2C and 2D depict basic components of a solution blow spinning system usable to produce ion exchange material according to the present technology;

FIG. 3A shows a FESEM image of spun sodium titanate (TiOₓ:Na) nanofibers in accordance with an embodiment of the present technology;

FIGS. 3B and C show FESEM images of spun zirconium oxide nanofibers of tetragonal structure and ZrO₂:Sb nanofibers in accordance with embodiments of the present technology.

FIG. 3D shows a graph of uptake of Sr-85 from 1 mM NaNO₃ solution on titanate nanofibers attached to a steel mesh (stainless steel (AISI 316), mesh size 77 μm), titanate mass 7 mg, flow rate 2.5 ml/h (360 sorbent masses/hour)(filled red squares); and the Sr-85 uptake of a column packed with the nanofiber (180 mg, flow rate 220 sorbent masses per hour) (blue circles).

FIG. 3E shows the dynamic column performance of Na-titanate nanofibers (42 mg) compared to that of granular Na-titanate (420 mg, 0.85-0.30 mm) in 0.5 ml minicolumns (bed volume BV 0.5 ml) for Sr-85 removal (inlet activity A₀=8400 18500 Bq/l; A=outlet activity)m in 1.0 M NaNO₃ solution. Flow rate 50 ml/h gradually increased to 195 ml/h, corresponding to 120-460 sorbent masses per hour (SM/h) for granular material and 1200-4600 SM/h for the nanofiber.

### DESCRIPTION OF EMBODIMENTS

In the present context, the term “inorganic ion exchanger” is generally used for designating an inorganic substance containing ions which are exchangeable with other ions, present in a solution in which the ion exchanger is considered to be insoluble.

Typically, the present inorganic ion exchanger is also capable of acting as a “sorbent”, preferably as a discardable sorbent, when used for example for removing radionuclides from solution. Thus, the expression “ion exchange” will be used to designate both ion exchange as such as well as sorption. The sorption can be either adsorption or absorption. At some instances, for the sake of clarity, both expressions, ion exchange and sorption, will be used to emphasize that both processes are possible.

“Bed volumes per hour”, when used to designate processing capacity, is calculated as volume per hour of liquid to be treated divided by volume of sorbent.

“Sorbent masses per hour”, when used to designate processing capacity, is calculated as mass of liquid to be treated per hour divided by mass of sorbent.

The present invention provides for the use of spun inorganic fibers as ion exchangers or sorbents. The fibers can be used as such or they can be used as support materials of particulate ion exchange materials. In both alternatives, the spun fibers exhibit ion exchange or sorbent properties.

In some embodiments, the inorganic spun fibers have a diameter in the range of 5 to 1000 nm, for example 15 to 990 nm, for example 15 to 500 nm. In particular, nanofibers (the diameter being less than 1000 nm) offer very high surface area to material volume ratio.

In the present embodiments, the fibers are “continuous” which means that they have an aspect ratio of 100:1 or more, in particular 500:1 or more, preferably 1000:1 or more, for example 10,000:1 or more. In one embodiment, the aspect ratio is in the range from 10,000 to 1 to 1,000,000:1.

Generally, the expression “continuous fibers” will be used to emphasize that the present fibers have a length considerably much greater than that of cut fibers, such as staple fibers.

Further, the fibers are curly which provides for the forming of monolithic structures due to self-entanglement of the continuous, curly fibers.

The present structures or fibrous units can be characterized as “monolithic”. Monolithic, as opposed to powder, means in this context an object that appears as a single piece on macroscopic scale.

In one embodiment, monolithic stands for mechanical structures formed by primarily one material only, both the surfaces and the internal parts of the structures being composed of the same material. Since in one embodiment the monolithic structures or fibrous units comprise of multiple continuous entangled curly fibers, the monolithic structures or fibrous units have a porous structure. Typically they are capable of being compressed together somewhat by mechanical forces in any direction in space.

The present structures are “macroscopic” in the sense that they have at least one dimension greater than 50 μm. This means that the structures are visible to the naked eye. Typically, the maximum size, in any dimension, of the structures, when formed by breaking up of fiber beds, as explained herein, is 100 mm, in particular 50 mm, for example 25 mm.

In the present context, “metal” includes alkaline metals, earth alkaline metals, non-transition metals and transition metals. “Metalloid” includes at least arsenic, tellurium, germanium, silicon, antimony, boron, polonium and aluminium.

Metals and, in particular, transition metal compounds of metals in groups 4 or 8, provide good ion exchange capability and manufacturability using spinning methods.

In one embodiment, the metal compound is selected from the group of transition metal compounds, such as a compound of scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, hafnium, tantalum, tungsten, rhenium, osmium, iridium, platinum, gold and mercury and combinations thereof.

In some embodiments, the metal compound is a metal oxide, such as a transition metal oxide, or salt thereof, or an iron cyanate, for example a hexacyanoferrate, or a salt thereof. The metal compound can also be a silicate or phosphate compound, such as a metal silicate or metal phosphate.

In some embodiments, the inorganic fibers are formed by alkaline or earth alkaline metal compounds. Examples of alkaline metals include in particular sodium, potassium and lithium and combinations thereof. Examples of earth alkaline metal compounds include calcium, magnesium, barium, strontium and beryllium compounds and combinations thereof. The alkaline or earth alkaline metal compounds can be in the form of oxides, phosphates, cyanates, silicates, iron cyanates and combinations thereof.

In some embodiment, the inorganic fibers are formed by at least one metalloid compound, such as a compound selected from the group of silicon compounds, antimony compounds, germanium compounds, and combinations thereof.

Based on the above, in embodiments of the present technology, the metal or metalloid compound is selected from the group of titanium oxides, zirconium oxides, zirconium phosphate, aluminium oxides, transition metal hexacyanoferrates, such as titanium, nickel or cobalt hexacyanoferrates, titanium silicates, aluminium silicates, antimony silicates, titanium antimonates, silicon antimonates and combinations and salts thereof.

The metal or metalloid oxides can be present in the form of alkali metal salts, such a sodium or potassium salts. Examples include in particular sodium titanate.

In some embodiments, the metal or metalloid compound further contains, in addition to a first metal or metalloid, at least one second metal or metalloid ion. For example, a first metal or metalloid compound can be doped with at least one second metal or metalloid ion. By including a second metal or metalloid ion, the properties of the ion exchanger can be modified and for example its selectivity for a particular metal or metalloid can be enhanced.

For example, the doping metal or metalloid can be selected from the group of transition metal compounds, such as a compound of scandium, titanium, vanadium, chromium, manganese, iron, cobalt, nickel, copper, zinc, yttrium, zirconium, niobium, molybdenum, technetium, rhutenium, rhodium, palladium, silver, cadmium, lanthanum, hafnium, tantalum, tungsten, rhenium, osmium, iridium, platinum, gold and mercury and combinations thereof.

The doping metal can also be selected from the group of alkaline metals, such as sodium, potassium and lithium and combinations thereof, and from the group of earth alkaline metals, such as calcium, magnesium, barium, strontium and beryllium compounds and combinations thereof.

The doping metalloid can be selected from the group of metalloids, such as arsenic, tellurium, germanium, silicon, antimony, boron, polonium and aluminium.

Examples of doped metal compounds include strontium oxide doped with antimony.

In some embodiments, the fibers comprise a polycrystalline material. Such a material has high selectivity. This, for example, allows for selective sorption of metals, such as radionuclides, from dilute solutions or dispersions containing various metal ions or particles, as will be discussed below. Based on the high selectivity of the present fibrous materials, they can also be incorporated, as a pre- or post-treatment layer(s), into conventional ion exchangers having high capacity.

The present structures are primarily formed by continuous fibers which are curly and entangled. The structures themselves are porous and monolithic (i.e. non-powdery) and irregularly shaped. The structures are porous in the sense that they allow passage of liquid through them, i.e. they structures are “liquid-permeable”.

Generally the monolithic structures have a porosity of at least 50%, typically over 90%, compared to dense particles of the same material with the same dimensions.

When arranged in the form of layers, the macroscopic, irregularly shaped particles will form interlocking structures, which are particularly suitable in static beds. Liquid effluents from ion-exchange or sorption will contain very little of suspended matter, if any at all.

In some embodiments, the material according to the invention is used for separating cations, anions or particles from liquids, such as aqueous media, for which a fibrous bed of inorganic matter suits well. Practical applications include e.g. separating radionuclides from nuclear waste liquids or solutions.

In some embodiments of the present fibers they can be used for binding colloidal particles from liquids. Thus, a pretreatment layer of fibrous inorganic ion exchangers, can be used as an active filter for reducing colloidal particles from aqueous feed conducted to an ion exchanger, such as a conventional granular ion exchanger.

In some embodiments, the inorganic fibers comprise additional particulate ion exchange materials. The additional particulate material can also be inorganic and amount to 1 to 90%, in particular 5 to 75%, for example at 10 to 50%, by weight of the total weight of the ion exchange material. Thus, a considerable amount of material still consist of the spun inorganic fibers which themselves are adapted to come into contact with the fluid to be subjected to ion exchange and therefore serve as ion exchange features in the material.

The particulate material can be the same or different from the fiber-forming material. For example, the particle material can be selected from sodium titanates, zirconium oxides, transition metal hexacyanoferrates, such as titanium, nickel or cobalt hexacyanoferrates, and antimony silicates, to mention some examples.

Particularly suitable fibers for the present use are those obtained by electrospinning or solution blow spinning or centrifugal spinning. They are capable of providing long inorganic nanofibers from a solution of organic and inorganic precursors. In case additional particulate ion exchange matter is desired, simultaneous electrospinning or solution blow spinning of precursors of the inorganic fibers and of particulate inorganic ion exchange materials can be taken advantage of. Also centrifugal spinning can be promoted by blowing or electric forces or combinations, thereof, for drawing threads or fibers.

The present ion exchange material can be obtained by spinning, for example by electrospinning, solution blow spinning or centrifugal spinning from a liquid phase containing organic and inorganic precursors of a material forming the inorganic fiber.

Electrospinning comprises charging the liquid phase, forming a liquid jet from the charged liquid phase so as to form a polymeric fiber, and removing organic components of the fiber, e.g. via calcination, for forming the inorganic fiber. In electrospinning, the liquid jet can be formed by pressurizing the liquid through a needle or using a needleless method, such as a twisted wire method.

Solution blow spinning, on the other hand comprises forming a liquid jet from the liquid phase, bringing the liquid jet in contact with a pressurized gas flow having a velocity higher than the velocity of the liquid jet for forming a polymeric fiber, and removing organic components of the fiber for forming the inorganic fiber. The jet and gas flow can be formed for example using a needle with an inner channel for the liquid and outer surrounding channel for the gas flow.

In centrifugal spinning, the liquid is placed in a rotating spinning head, such as a cylinder with orifices on peripheral surface of the structure, from which the liquid is forced or drawn to fibers or threads by the use of centrifugal forces.

Electrospinning and solution blow spinning can be combined so that both liquid charging and pressurized gas flow are used to form the fibers for increasing productivity and controllability of the process. This technique is called electroblowing.

The fibers obtained by the above mentioned methods are continuous, curly and randomly oriented into large fiber sheets comprising of a single entangled fiber network. The as-spun fiber sheets comprising the organic and inorganic precursors are flexible and bendable.

The removal of organic components of the fiber (“removal phase”) can comprise e.g. burning off the organic content of the fibers. Removal of the organic components, e.g. via calcination, to form the inorganic fibers results in generally more rigid and fragile fiber sheets.

Typically, calcination is preferably carried out such as to provide a material which is throughout inorganic, and which therefore contain no organic materials at all, or at the most only small amounts or traces of organic materials. Thus, it is preferred to provide a material which contains less than 10%, in particular less than 5%, preferably less than 1% by weight of carbon of organic materials, in particular organic impurities.

In one embodiment, calcination is carried out at a temperature higher than at least about 300° C., in particular at a temperature of at least 400° C., typically a temperature of 450° C. or more, for example at 500 to 800° C. Calcination can be carried out in one stage or in several stages, in the letter alternative typically at different temperatures within the general temperature range given. As will appear from the examples, for polymeric fibers wherein the polymer is selected from the group of polyvinyl pyrrolidone (PVP), polyvinyl alcohol (PVA), polyvinyl acetate (PVAc), polyethylene oxide (PEO), and polylactide (PLA), temperatures of at least 300° C., typically at least 450° C., are sufficient to achieve calcination. Calcination times can vary. Typically calcination is carried out for a total time of at least 10 minutes and up to about 1440 minutes, for example 30 to 720 minutes, in particular 30 to 600 minutes. If calcination is carried out in several stages, the duration of each stage can be from 10 to about 720 minutes, in particular about 20 to 600 minutes.

This inorganic network structure can be cut or broken into smaller macroscopic particulate material comprising tangled continuous fibers akin to a ball of thread or twine. The balls of thread like structures comprise several rigid fiber threads in monolithic network structures. In preferred embodiments, the fibers, having an aspect ratio of 100:1 or more, in particular 500:1 or more, preferably 1000:1 or more, are continuous and tangled into monolithic liquid permeable macrostructures with a minimum dimension greater than 50 μm, for example greater than 75 μm or even greater than 100 μm.

Based on the above, one embodiment comprises a method of producing an inorganic material using the steps of
orientating continuous inorganic fibers having a diameter smaller than 1 μm into a fiber sheet comprising a network of entangled fibers;
removing any residues of organic substances from the inorganic fibers; and optionally
breaking up the inorganic network structure thus obtained to form a particulate material having one dimension of at least 50 μm.

In a preferred embodiment, the inorganic fibers are used in as-spun condition for forming fibers sheets, and in another preferred embodiment, the fibers sheets are subjected to a heat treatment, in particular calcination, for removing organic residues from the fiber sheets.

In a particularly preferred embodiment, a fiber mat or a particulate matter consisting of inorganic material is provided.

In one embodiment, the fiber mats have at least one dimension which is 50 μm or more. Typically, the smallest size of the mat is at least 50 μm. Thus, for example, the thickness of the mat is generally 50 μm to 10,000 μm. The length of the mat can be 50 μm to 500 mm and the width similarly 50 μm to 500 mm.

In one embodiment, the particulate material has at least one dimension of 50 μm or more, for example it has at least two dimensions of 50 μm or more. The minimum dimension of the particulate material can be at least 75 μm, for example at least 100 μm. Generally, the maximum dimension of the particular material is 1,000 to 10,000 μm in any direction.

As a result, the inorganic material produced from fibers with a submicron diameter, will have a macroscopic secondary structure which allows for ease of handling. The fiber mats as such formed by the monolithic structures, as well as the individual, irregularly shaped particles of monolithic structures, can be mechanically manipulated.

All materials disclosed herein are suitable for use in ion exchange beds as such or as components thereof, for example as sorbents, such as discardable sorbents. Preferably, the fiber structures of the bed are randomly packed to form a three-dimensional network.

In one embodiment, a bed according to the present technology comprises a single monolithic fiber mat or a plurality of monolithic fiber structures. In the latter case, the bed can comprise some 1 to 2,500,000 particles/cm³, for example 100 to 1,000,000 particles/cm³.

Typically, the bed has a processing capacity of 10 to 5000 bed volumes, in particular 100 to 500 bed volumes, per hour.

According to one embodiment, the present ion exchange unit comprises an ion exchange bed of the kind described above disposed within a housing between an inlet for liquid to be subjected to ion exchange and an outlet for liquid having been subjected to ion exchange.

Typically, the bed has an elongated form, wherein the liquid is adapted to flow from first end thereof which in liquid connection with the inlet to an opposite second end thereof which is in liquid connection with the outlet.

In one embodiment, the inlet and outlet are placed at different locations of the ion exchange unit to allow for continuously or semi-continuously withdrawing liquid from the ion exchange unit through the outlet.

In one embodiment, the unit is capable of continuous operation by allowing for liquid flow from the inlet through the ion exchange or sorption bed to the outlet.

In one embodiment, the unit is operated in fluidized bed mode.

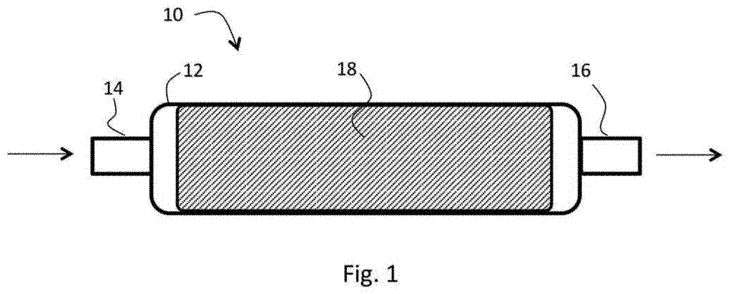

Turning now to the drawings which illustrate some of the above embodiments, it can be noted that FIG. 1 shows an ion exchange unit 10 according to one embodiment. The unit 10 comprises a housing 12 containing a bed 18 of inorganic ion exchange material in the form of spun fibers forming a three-dimensional, macroscopic structure of the present kind. The material can be a fiber mat, for example comprising one layer or, in particular 2 to 50, for example 2 to 10 overlapping layers of fibers. Alternatively, the ion exchange material can comprise particulate material according to the embodiments above.

The housing 12 has a fluid (typically liquid) inlet 14 and an outlet 16 between which the bed 18 is arranged. The housing 12 is designed to conduct liquid brought to the inlet 14 to a first end of the bed 18, then through the bed 18 and finally out from the second end of the bed and out of the housing 12 through the outlet 16.

In one embodiment, the unit 10 forms a cartridge or cassette, which is intended to fit into an ion exchange portion of a larger ion exchanger system. In this case, the housing 12 typically comprises, on outer surface thereof, guide or retaining means (not shown) for immobilizing the housing 12 in a suitable position and/or orientation within a suitable slot, i.e. cassette- or cartridge-receiving zone, of the system. The housing 12 can also be otherwise shaped so as to fit in such slot. The system is provided with liquid conduits that are connected to the inlet 14 and outlet 16 of the unit 10 when the unit 10 is in the slot.

In one embodiment, the housing 12 comprises means for replacing the ion exchange bed 18 contained therein. The bed 18 can be provided in the form of a self-supporting ampoule, whereby the housing 12 provides an accommodation zone for the bed 18 and a liquid-guiding function for the unit 10 through the bed 18.

For maximum recyclability, it is also possible to combine the abovementioned embodiments such that the unit forms a cassette or cartridge capable of being installed as a functional part of an ion exchange system and wherein the ion exchange bed inside the housing of the cassette or cartridge is also replaceable.

The unit can be designed to operate in horizontal orientation, vertical orientation (such in a column, for example), or any other suitable orientation. Typically, the ion exchange bed has an elongated form, i.e. its dimension in the fluid flow direction being greater than its dimensions in the perpendicular dimensions, for allowing a sufficient time of residence for the fluid within the bed in contact with the inorganic fibers. However, it is equally possible to manufacture more planar filter beds with different dimensions.

Next, two spinning methods which both can be used for the manufacture of the present fibers will be briefly described.

Both methods are particularly suitable for the production of fibers whose average diameter is less than 1000 nm (nanofibers), typically 5-500 nm, but are suitable also for the production of fibers with average diameter in the micrometer range, such as 1-10 μm (microfibers). After that, optional processing steps, such as calcination are introduced, after which exemplary uses of the fiber material are discussed.

Fabrication of Inorganic Fibers by Electrospinning

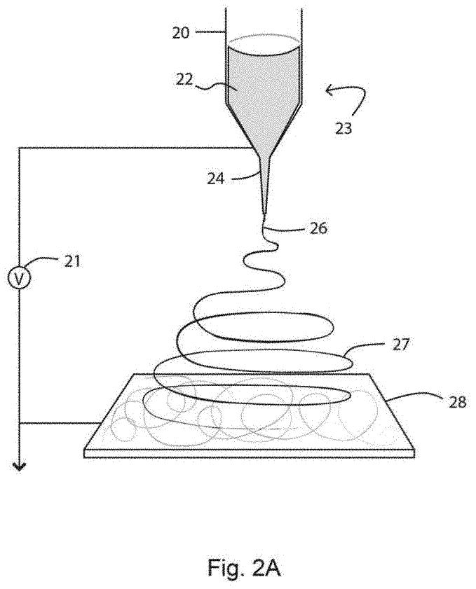

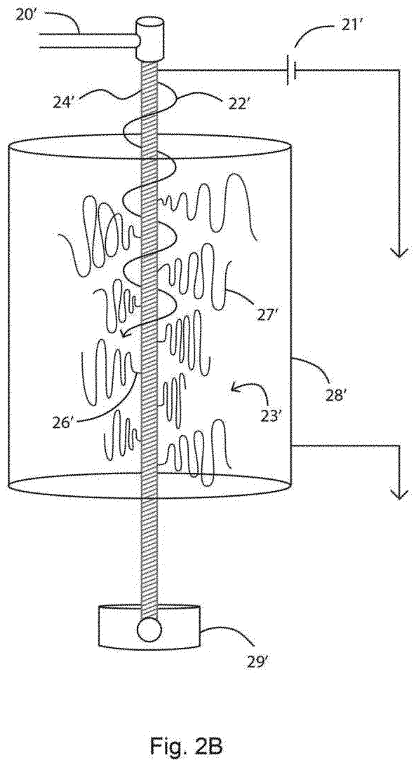

Electrospinning is a relatively simple, versatile and upscalable method for preparing micro- and nanosized fibers suitable for the present use. FIG. 2A shows the basic principle of electrospinning process, in which an electrical charge is used to spin very fine fibers from a precursor solution. There is provided a spinneret 23 comprising syringe 20 containing precursor 22, such as a polymer solution or melt. The spinneret 23 also comprises a needle 24 extended from the syringe 20 for forming a thin liquid jet 26 out of the precursor 22. The precursor 22 is charged prior to forming the jet 26 by coupling a voltage source 21 to the syringe 20, or even more typically the needle 24 so that the precursor 22 is electrically charged. Once the precursor 22 exits the needle, electric forces cause the precursor 22 to repel itself, resulting in the formation of a very thin fiber 27. A so-called Taylor cone is formed at the tip of the needle 24. Typically, the process causes the fiber to take a curly form. The formed fiber 27 is collected using a collector 28 typically connected to the ground potential.

By changing electrospinning parameters, for example voltage with a voltage source 21 and spinneret-collector distance, fibers of different diameters, including the nano- and/or microfibers suitable for the present use, can be obtained. With different electrospinning setups it is also possible to prepare hollow fibers.

The spinneret and the collector can also be of a form different from that shown in FIG. 2A.

FIG. 2B shows a twisted wire configuration as an example. The spinneret 23′ comprises a twisted wire 24′, such as a twisted metal wire, along which the precursor 22′ coming from a reservoir (not shown) through an input channel 20′ and charged with a voltage source 21′ is fed from top to down. The charge causes a plurality of Taylor cones to form along the length of the wire 24′ and a plurality of polymer jets 26′ to form. Fibers 27′ formed from the jets 26′ are collected on a cylindrical collector 28′ which is placed around the wire 24′. The collector 28′ can comprise a mesh or the like conducting structure which is coupled to ground potential. This arrangement increases the production rate of the process considerably compared with single-needle arrangements.

Fabrication of Inorganic Fibers by Solution Blow Spinning

Solution blow spinning is an alternative to electrospinning. Solution blow spinning can also be used to supplement electrospinning, whereby jet-forming features of both methods are employed. This is called electroblowing.

FIG. 2C shows key parts of an exemplary solution blow spinning system. The system comprises a tank 31 of pressurized gas connected to a blowing nozzle 34. A pressure gauge and/or regulator 32 is used to monitor and/or control gas pressure. A source of precursor is also connected to the nozzle 34 using a suitable injection pump 33.

FIG. 2D shows an exemplary solution blow spinning nozzle. The nozzle comprises a precursor channel 37 connected to the injection pump 33 and a gas channel 36 connected to the gas tank 32. The gas channel 36 at least partially surrounds the precursor channel 37 so that precursor and gas flow exit the nozzle side by side so as to form a precursor/gas boundary 38 at the tip of the nozzle. The velocity of gas is higher than that of the injected precursor, whereby the gas flow takes the precursor with it and elongates fibers from the precursor.

The fibers spun this way ware collected with a collector 35 arranged in a position where the gas flow conveys the fibers.

In both embodiments, spinning is continued until a thread-like, continuous fiber material is obtained as a continuous fiber sheet. After transformation, e.g. by annealing, of the as-spun fiber material into inorganic fibers a rigid and fragile inorganic fiber network is obtained.

These fiber networks can be cut or broken into smaller monolithic structures of said entangled continuous fibers. In one embodiment, such continuous tangled fibers form monolithic structures having a minimum dimension of at least 500 μm, preferably at least 750 μm.

Precursors for Spinning, Composition and Processing of Fibers and Further Aspects

According to one embodiment, the inorganic fibers are produced from a solution of organic and inorganic precursors. Typically, the organic and inorganic precursors are soluble or at least dispersible in the same liquid. Such solution may contain at least one organic precursors, in particular a polymer, such as polyvinyl pyrrolidone (PVP), polyvinyl alcohol (PVA), polyvinyl acetate (PVAc), polyethylene oxide (PEO), and polylactide (PLA), as well as combinations thereof and at least one inorganic matter-containing compound, such as metal-containing compound, which eventually forms the body of the inorganic fibers capable of ion exchange. For silicon fibers, silane compounds or monomers, such as TEOS (tetraethoxy silane) or MEOS (tetramethoxy silane) can be used.

Further the solution contains a solvent. The solvent may comprise or consist of a polar or non-polar compound, particularly preferred compounds are protic compounds. Examples of suitable liquids comprise alcohols, such as lower alkanol (a C₁-C₄ alkanol), for example ethanol. Combinations of the afore-mentioned compounds can, naturally, also be employed.

The inorganic compounds typically undergo one or more chemical reactions, such as oxidation during a calcination stage after spinning, before reaching their final form. In a typical case, the inorganic material of the fibers is ordered in polycrystalline form.

Preferred inorganic materials are transition metal compounds, in particular those in groups 4 or 8. In particular transition metal oxides or salts thereof provide efficient ion exchange capabilities, sufficient mechanical strength and are suitable for the spinning processes available. Detailed examples using titanium and zirconium are given in the Examples section. Another preferred material comprises metalloid compounds, such as silicates or germinates.

In some embodiments, the metal compound further contains, in addition to a first metal, a second metal ion. For example, a first metal compound can be doped with a second metal ion.

The fibers, and optional additional particles, can be spun onto various surfaces and different types of structures serving as collectors of the fiber mass. In a typical electrospinning case, there is a metal plate or a metal mesh onto which the mass is collected. According to one embodiment, the mass is spun directly into a housing of an ion exchange unit, i.e. to its final position where the mass serves as the ion exchange bed. This makes it very convenient to construct ion exchange beds and units with different capacities and for different users. As described above, the units can be, but are not limited to, columns, cartridges, cassettes, filters etc.

At least if manufactured from an organic, such as a polymeric precursor, the mass collected at the end of the spinning process contains organic material, which is preferably removed to obtain pure inorganic fibers. A calcination stage can be employed to remove organic matter from the fibers. The calcination can comprise e.g. subjecting the nanofibers to an elevated temperature of at least 300° C., typically at least 450° C., for a predefined time, which can be at least 30 minutes and typically at least 2 hours in the presence of oxygen (typically in air). During calcination, metals potentially present in the fibers are oxidized to more efficient ion exchange materials.

The fiber mass obtained as a result of the spinning process, and optionally calcined, can be used as ion exchange material as such. The fibers are typically collected as a permeable and self-supporting fiber mass with essentially randomly oriented fibers. The mass can as such serve as ion exchange bed but it may be also mechanically processed further to form a suitable bed. For example, if the mass is collected as a thin fiber mat, several such mats may be stacked on top of each other so as to form larger ion exchange bed structures, if needed.

According to one embodiment, additional powder-formed ion exchange material is electrospun to a fibrous bed of ion exchange material. Thus, the inorganic fibers also act as a supporting structure for the particles of the powder. The spinning of the additional material may take place at the same time of spinning the fibers by using a suitable precursor or the particles may be bound to the fibers in another step. The amount of particulate matter in the bed is typically 90 wt-% at maximum and preferably does not exceed 50 wt-%. The powder may comprise for example sodium titanate, zirconium oxide or nickel or cobalt hexacyanoferrates or any mixture thereof.

According to a further embodiment, the supporting fibers, if not initially suitable for ion exchange, are transformed chemically so as to act as ion exchange material. Together with the particles, this creates an ion exchange bed with two different ion exchangers.

In one embodiment, the fibrous mass is free from particulate matter capable of ion exchange reactions, and preferably from other particulate matter too. According to a further embodiment, the ion exchange bed consists of a network of the inorganic spun fibers.

### Examples

Manufacturing of TiOₓ:Na, ZrO₂ and ZrO₂:Sb Fibers

Precursor solutions for electrospinning and electroblowing of TiOₓ:Na were made by preparing first 7 and 12 wt % PVP (polyvinyl pyrrolidone, Mw—1 300 000 g/mol) solutions with absolute ethanol (EtOH) as a solvent. TiOₓ:Na precursor solution was prepared by dissolving 1.5 ml titanium isopropoxide and 0.267 g sodium acetate into 6 ml of ethanol/acetic acid solvent mixture (volume ratio 1:1). The titanium to sodium molar ratio in the solution was about 1.55. Next 7.5 ml of the 7 or 12 wt % PVP/EtOH solution was added into the solution to prepare the final electrospinning and electroblowing solutions, respectively. The solutions were stirred for about 1 h.

A ZrO₂ precursor solution was prepared by dissolving about 3.2 g zirconium acetylacetonate into a solution that contained 2.3 ml acetic acid and 5.5 ml ethanol. After 15 minutes mixing, 0.5 g polyvinylpyrrolidone was added to the solution and the mixing was continued for about 1 h.

A ZrO₂:Sb precursor solution was prepared by dissolving about 3.100 g zirconium acetylacetonate and 0.100 g antimony(III)acetate into solution that contains 2.8 ml acetic acid and 6.7 ml ethanol. After 15 minutes mixing 0.67 g polyvinylpyrrolidone was added into solution and mixing was continued for about 1 h. The cation content in the final product is about 5% antimony and 95% zirconium.

All three metal-containing precursor solutions discussed above were spun into fibers using electrospinning. Each solution was first placed into a plastic syringe. Using a peristaltic pump, the precursor solution was delivered to a metal needle with a constant flow rate of 0.648 ml/h. The needle was connected to a high voltage supply. The distance from the needle tip to a metallic collector grid was set at 15 cm. Fibers were ejected from the needle tip when a high voltage of 15 kV was applied.

TiOₓ:Na precursors containing fibers were electroblown from an apparatus where compressed air was delivered through a 3 mm metal nozzle with a gas flow rate of 30 Nl/min. A 27 gauge needle set to a high voltage of 15 kV was placed at the center of the nozzle protruding 1 mm from nozzle and the electroblowing solution was pushed through the needle with a syringe pump with a solution feed rate of 15 ml/h. The fibers ejected from the needle were collected on grounded metal grid collectors.

The collected electrospun and electroblown fibers were calcined at 500° C. for 4 h in air. During the calcination organic parts of the fibers were removed and metal precursors were oxidized to metal oxides.

Characterization of Products

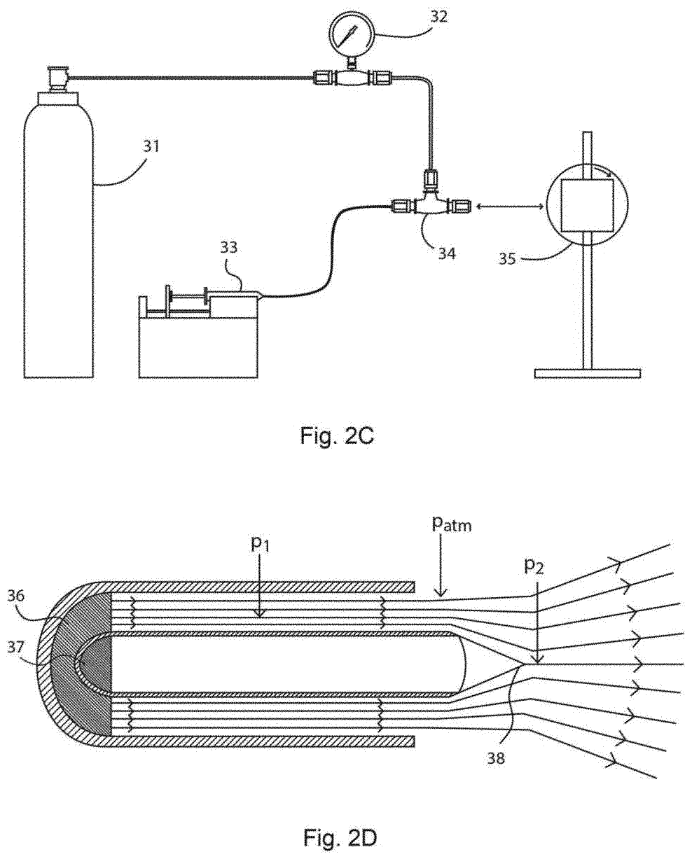

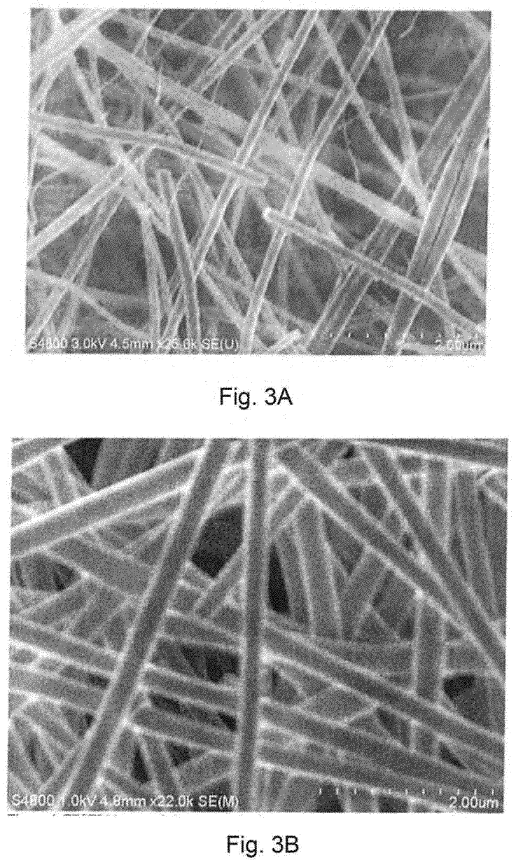

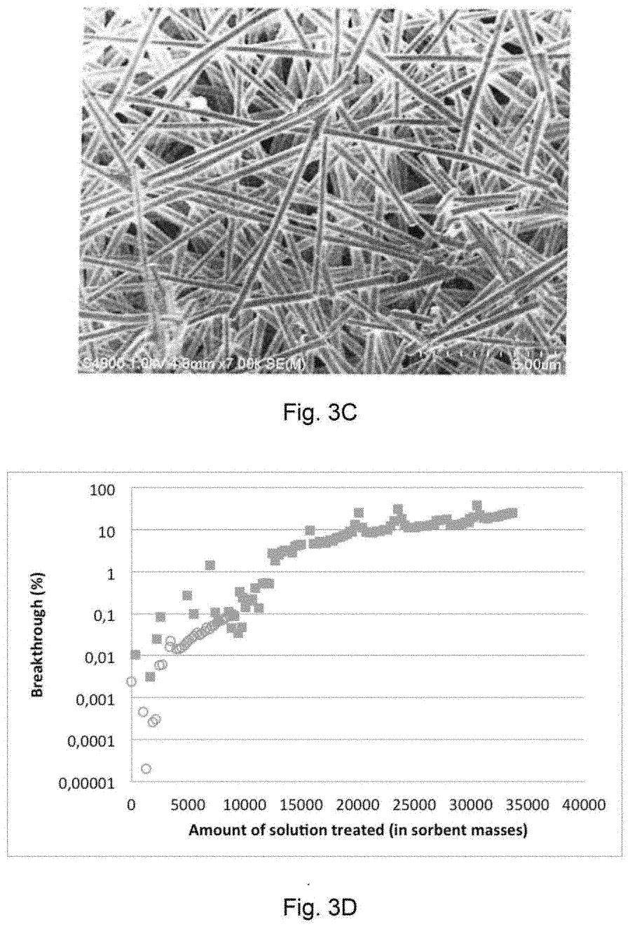

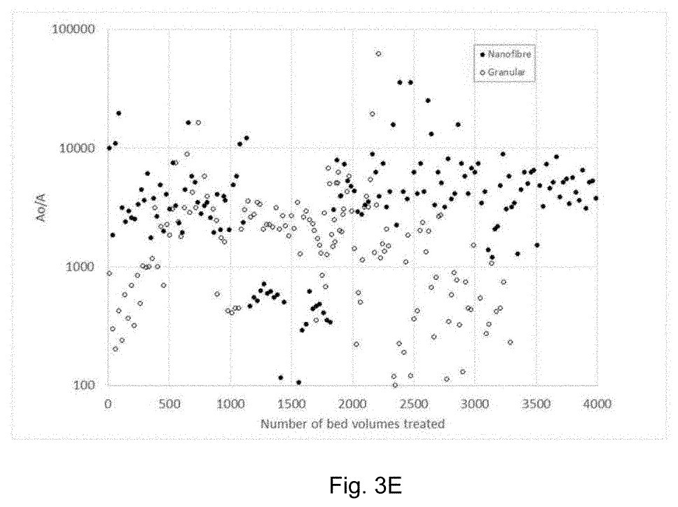

The composition and structure of the three products manufactured as described above, i.e. TiOₓ:Na, ZrO₂ and ZrO₂:Sb fibers, were verified with XRD, FESEM and EDX. Exemplary FESEM images of the respective products are shown in FIGS. 3A, 3B and 3C. Based on the verifications, the products were found to practically entirely consist of long fibers that were well oxidized, and the overall structure of the products was suitable to be used as ion exchange medium.

The TiOₓ:Na nanofibers of FIG. 3A adhered to a steel mesh removed e.g. radiostrontium from solution with a good efficiency, allowing a flow rate that is an order of magnitude higher (in terms of sorbent mass) than what can be used with conventional granular titanate material, see FIG. 3D.

The ZrO₂ nanofibers of FIG. 3C had a tetragonal structure. They were tested for the uptake of Sb-124 from primary coolant water from a nuclear power plant. Sb-124 was present in oxoanionic form in this solution and is not removed by conventional mixed organic resins used at the plant. Tentative batch uptake experiments showed a distribution coefficient of 7000 ml/g for Sb-124, which is clearly higher than for commercial granular material (1000 ml/g).

Column Experiments of Nanofibers

Here are demonstrated the function of nanofiber in two ion exchange columns for the uptake of Sr-85. The breakthrough percentage of Sr in y-axis and solution passed through the column in x-axis as mass of the ion exchange material.

Nanofiber collected in steel mesh (Stainless steel (Aisi 316), mesh size 77 μm) that was rolled inside of a glass tube to represent an ion exchange column is displayed in red, filled square legends (FIG. 3D). The solution in this experiment was 1 mM NaNO₃ and it was traced with Sr-85 isotope. The flow of the solution was calculated as 360 sorbent mass (7 mg) per hour.

The blue circular legends in FIG. 3D represent a more traditional ion exchange column (mini column with bed height of 10 mm and diameter of 12 mm) where the flow rate was 220 sorbent masses (180 mg) per hour (equals 36 bed volumes per hour). The solution in this experiment was 0.1M NaNO₃ traced with Sr-85 isotope.

FIG. 3E shows comparative performances of conventional granular Na-titanate and Na-titanate nanofibers. In spite of the much higher relative flowrate (1200-4600 sorbent masses per hour), the nanofiber material gives clearly higher degree of purification (Ao/A) than the granular material (120-460 sorbent masses per hour) for Sr-85.

Thus, the decontamination factor of the present materials is higher which means that the residual radioactivity of the effluent will be lower than for conventional, granular ion exchange materials.

### INDUSTRIAL APPLICABILITY

The present inorganic spun fibers can be used as ion exchange media. Thus, the inorganic spun fiber mass can be used to filter or purify a process water of industry, such as (electric) power industry, mining industry or bioindustry, such as forest industry, or water industry. All these branches of industry produce various aqueous media loaded with cations, anions and/or charged particles, which can be removed, and optionally recovered, by means of the present fibrous material.

Another remarkable area of application is the filtering of radionuclides from nuclear waste liquids or solutions. Such liquids may contain e.g. antimony, arsenic, barium, cesium, iodine, iron, silver, strontium and technetium, and in particular radioactive isotopes thereof, which can be separated using the present material. Separation can take place at a nuclear fuel production plant, nuclear power plant, nuclear waste processing plant or nuclear material refining plant, to mention some examples.

In addition to process water filtering/purification systems, the present material can be used in filter units of process monitoring and/or control systems.

The systems may comprise means for regeneration of the present fibrous bed and potential recovery of the captured ions, using a washing stage or the like.

When used for removing radionuclides from liquids containing such species, the fibrous bed can be disposed after use.

In addition to aqueous media, the present material suits for ion exchange within liquids based on other solvents.

### REFERENCE SIGNS LIST

10 ion exchange unit
12 housing
14 fluid inlet
16 fluid outlet
18 ion exchange bed
20 syringe
20′ input channel
21; 21′ voltage source
22; 22′ precursor
23; 23′ spinneret
24 needle
24′ twisted wire
26, 26′ liquid jet; polymer jet
27; 27′ thin fiber
28; 28′ collector
31 tank
32 regulator
33 injection pump
34 blowing nozzle
35 collector
36 gas channel
37 precursor channel
38 precursor/gas boundary
35 collector

### CITATION LIST

### Patent Literature

US 2009/0166295
US 2011/0274927
WO 2014/0168628
US 2016101408
JP S61187939
JP S58156347
U.S. Pat. No. 3,994,740
U.S. Pat. No. 5,707,922

### Non-Patent Literature

Wang, H et al., J. Hazard. Mater., December 2013, vol. 265, pp. 158-165.
Jianlian Liu et al., J. Radioanal. Nucl. Chem., 2013, vol. 298, pp. 1427-1434.
Jinming Luo et al. in Environ. Sci. Technol., 2015, 49, pp. 11115-11124.

1. An inorganic material capable of binding cations, anions or colloidal particles or mixtures thereof from liquid media by ion exchange or sorption, said material comprising:
continuous inorganic fibers having a diameter smaller than 1 μm,
said fibers being entangled and present in the form of a monolithic structure with at least one dimension of 50 μm or more.

2. The material according to claim 1, wherein the fibers have an aspect ratio of 1000:1 or more.

3. The material according to claim 1, wherein the fibers comprise spun inorganic material.

4. The material according to claim 1, wherein the inorganic fibers are formed by at least one metal or metalloid compound.

5. The material according to claim 4, wherein the at least one metal or metalloid compound comprises a metal compound, and wherein the metal compound is selected from the group consisting of transition metal compounds, alkali metal compounds, earth alkaline metal compounds, and combinations thereof.

6. The material according to claim 4, wherein the metal or metalloid compound comprises a metal oxide or a salt thereof, or a metal phosphate, or a salt thereof.

7. The material according to claim 4, wherein the metal or metalloid compound is selected from the group consisting of titanium oxides, zirconium oxides, zirconium phosphate, aluminium oxides, transition metal hexacyanoferrates, titanium silicates, aluminium silicates, antimony silicates, titanium antimonates, silicon antimonates, combinations thereof, and salts thereof.

8. The material according to claim 4, wherein the metal or metalloid compound is doped with at least one second metal or metalloid ion.

9. The material according to claim 1, wherein the inorganic fibers have a diameter in the range of 5 to 950 nm 15 to 500 nm.

10. (canceled)

11. The material according to claim 1, wherein the inorganic monolithic structures contain less than 10% by weight of carbon derived from organic compounds.

12. The material according to claim 1, wherein the inorganic monolithic structures are provided in the form of fiber mats or in the form of particulate matter having at least one dimension with a size of at least 100 μm.

13. An ion exchange or sorption bed comprising the inorganic material of claim 1 capable of binding cations, anions or colloidal particles or mixtures thereof from liquid media by ion exchange or sorption.

14. (canceled)

15. The bed according to claim 13, wherein the bed comprises a single monolithic fiber mat or multiple monolithic fiber structures.

16-18. (canceled)

19. An ion exchange unit, comprising a housing with:
an inlet for liquid to be subjected to ion exchange, and
an outlet for liquid having been subjected to ion exchange, said housing further comprising:
a bed of an ion exchange material, said bed having a first end which is in liquid contact with the inlet and an opposite second end which is in liquid contact with the outlet, and
said ion exchange material comprising continuous inorganic fibers having a diameter smaller than 1 μm, said fibers being entangled and present in the form of a monolithic structure having at least one dimension of about 50 μm or more.

20. (canceled)

21. The ion exchange unit according to claim 19, wherein the inlet and outlet are placed at different locations of the ion exchange unit to allow for continuous or semi-continuous withdrawal of the liquid from the ion exchange unit through the outlet.

22. (canceled)

23. The ion exchange unit according to claim 19, wherein the unit is operable in a fluidized bed mode.

24. A method of producing an inorganic material capable of binding cations, anions or colloidal particles or mixtures thereof from liquid media by ion exchange or sorption, said material comprising:
forming a plurality continuous inorganic fibers having a diameter smaller than 1 μm into a fiber mass comprising an entangled network of the inorganic fibers;
optionally breaking up the fiber mass; and
recovering the fiber mass in the form of a monolithic structure having a smallest dimension of about 50 μm or more.

25. (canceled)

26. The method according to claim 24, wherein the fibers sheets are subjected to a heat treatment for removing organic residues from the fiber sheets.

27. The method according to claim 24, wherein any organic residues are removed via calcination from the fiber sheets before the network is recovered for use, or broken up to form the material.

28. (canceled)

29. The method according to claim 24, wherein the forming is done by electrospinning, solution blow spinning, electroblowing, or centrifugal spinning.
